(19) United States
(12) Patent Application Publication
(10) Pub. No.: US 2011/0102685 A1
(43) Pub. Date: May 5, 2011

(54) Digital Picture Frame with Cellular Data Communication Functionality

(76) Inventor: Brian Kanter, Lincoln, NE (US)

(21) Appl. No.: 12/608,475

(22) Filed: Oct. 29, 2009

(51) Int. Cl. H04N 5/66; H04W 4/00

(52) U.S. Cl. 348/739; 455/466; 348/E05.133

(57) ABSTRACT

A digital picture frame is disclosed with integrated wireless data communication functionality for receiving digital pictures from an account associated with the digital picture frame. A method of receiving digital pictures is disclosed, including the steps of establishing an account to receive the digital pictures, retrieving the digital pictures from the account directly to a digital picture frame, and displaying the pictures.

### BACKGROUND AND PRIOR ART

Digital photography has essentially supplanted film photography in the consumer market. The transition has been rapid and total. Some consumers have a limited capacity to adapt to the new technology.

A person wishing to share digital photographs will generally send the photographs attached to an e-mail through a general purpose computer, or attached to a text message through a cellular telephone. Those methods require all of the recipients to have e-mail accounts and computers, or cellular telephones with text messaging service to access them. Each recipient also has to have the technical expertise to access their e-mail or text messages, and the fortitude to check them regularly. Alternatively, digital picture files can be copied to a compact disc, or some other media, and sent to a recipient in a physical form that may be more accessible to the recipient. That methodology still requires the recipient to have a computer, and it still requires the recipient to have the technical expertise to access the media.

For those recipients that lack the technical expertise to operate a general purpose computer effectively, the only viable alternative is to produce physical prints of the digital files, and send those prints to the recipient. That method sacrifices many of the advantages of digital photography.

Digital picture frames make digital photographs more engaging by not requiring a general purpose computer to view photographs, and by making the photograph viewing experience more familiar to those people who may lack the technical proficiency to use a general purpose computer. But digital picture frames actually add a level of complexity to the process of viewing digital pictures because the user has to actually transfer the pictures into the digital pictures frame. If the user is the same person who took the pictures, that process may be as simple as inserting a memory card into the digital picture frame. But if the user is not the same person, the user generally has to transfer the pictures onto a general purpose computer first, then plug the digital picture frame into the general purpose computer, then transfer the pictures to the digital picture frame. If the user is not already technically proficient, the process can be psychologically daunting.

What is needed is a device and method to transmit and display digital pictures without the need of a general purpose computer.

### SUMMARY

The present invention is directed to a device and method that satisfies the need to easily transmit and display digital pictures without the need of a general purpose computer.

A digital picture frame having features of the present invention comprises a central processing unit, a memory storage means functionally connected to the central processing unit, a wireless data transmission means functionally connected to the central processing unit, and a display means. The digital picture frame may also include a user input means functionally connected to the central processing unit.

The digital picture frame may be associated with an e-mail account hosted by a third-party; such e-mail account receives and stores e-mails sent to the account. The digital picture frame would access the e-mail account through the wireless data transmission means.

The digital picture frame may be associated with a cellular telephone account. The digital picture frame may access the cellular telephone service provider through the wireless data transmission means and receive any text messages with attached pictures. Alternatively, the cellular telephone service provider may access the digital picture frame through the wireless data transmission means and push text messages with attached pictures to the digital picture frame by means essentially identical to those used to push text messages to cellular telephones.

A method for receiving and displaying digital pictures without the need of a general purpose computer having features of the present invention comprises the steps of establishing an account to receive e-mails or text messages with digital pictures attached, establishing a connection to the account through a digital picture frame capable of such connection, downloading the e-mails or text messages with digital pictures attached from the account into a memory storage means of the digital picture frame, and displaying the digital pictures. The connection established through the digital picture frame to the account may be through a cellular telephone service provider. The method may further comprise the steps of encoding the senders e-mail address or telephone number as metadata, and incorporating said metadata in to the digital picture.

### LIST OF FIGURES

FIG. 1 shows a flowchart of a version of a method embodying features of the present invention to send digital pictures to a digital picture frame without a general purpose computer.

FIG. 2 shows a flowchart of a version of a method embodying features of the present invention to send digital pictures to a digital picture frame through a cellular telephone provider.

FIG. 3 shows a diagram of a version of a device embodying features of the present invention.

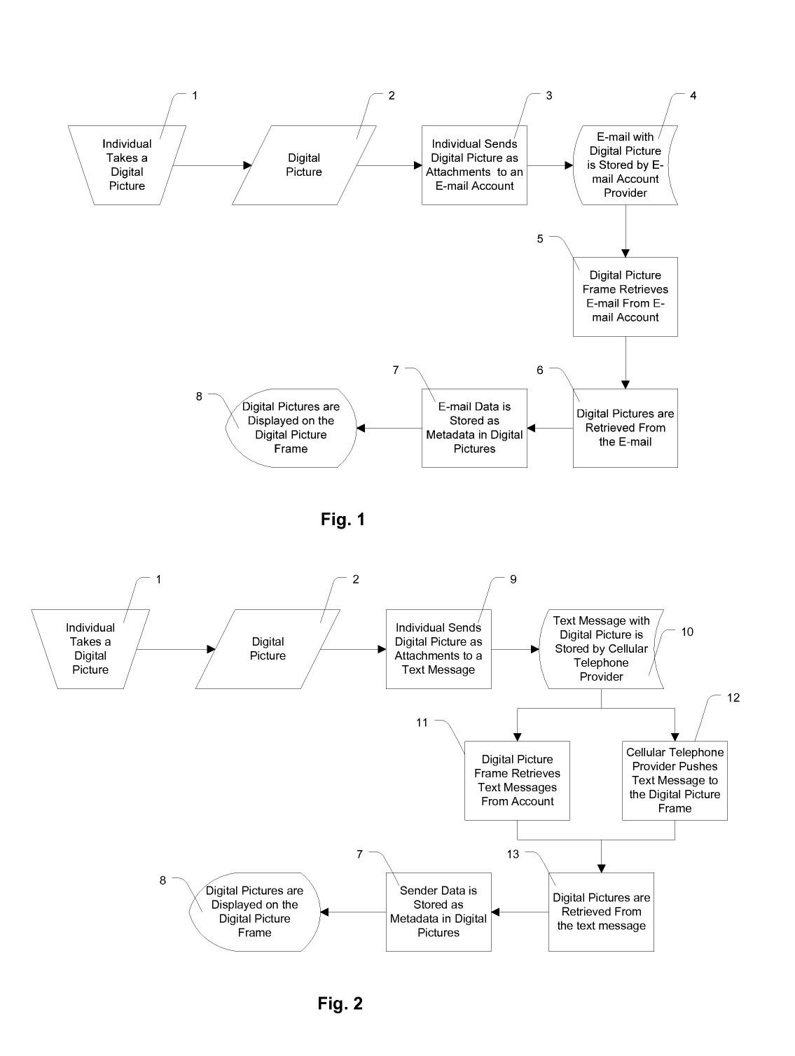

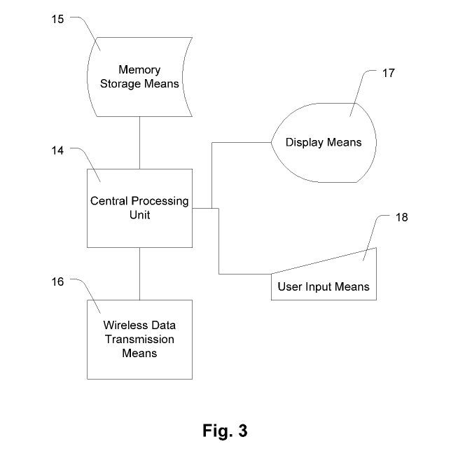

### DESCRIPTION OF INVENTION

In the following description, the inventor generally intends that all words should have their ordinary meaning within the art. In the interest of clarity, the inventor wishes to provide the following guidance as to the meaning of certain terms or phrases; but such guidance should not exclude otherwise consistent meanings which are ordinary and customary within the art.

Cellular telephone network, or cellular telephone service provider are intended to refer to GSM and UMTS cellular telephone networks and the service providers who operate those networks, but nothing in this application should be understood to limit the application to those systems.

Text message is intended to refer to any data transmission sent by any protocol through a cellular telephone service provider; the present invention specifically applies to text messages with digital pictures attached, which would normally be sent by the MMS protocol, but nothing in this application should be understood to limit the invention to messages sent solely by that mechanism. Text messages should be understood to include multimedia messages as well.

Account is intended to refer to an e-mail account hosted by a third-party, or a cellular telephone account that receives and stores text messages and multimedia messages. Account should be understood to refer to a service provided by a third-party to receive and store communications, and re-send those communications. The term communications is intended to refer to e-mail or text messages as previously defined.

The present invention comprises a digital picture frame comprising a central processing unit (14), a memory storage means (15) functionally connected to the central processing unit, a wireless data transmission means (16) functionally connected to the central processing unit, and a display means (17).

The central processing unit, memory storage means, and display means are known in the art. The inventor envisions that they will be assembled and function normally as a digital picture frame. The wireless data transmission means is also known in the art. Such means include Wi-Fi, Bluetooth, cellular telephone network or other radio frequency transmission means capable of sending and receiving data, and connecting to a digital computer network.

The wireless data transmission means has the sole function of connecting to an internet service provider or cellular telephone network, and thereby allow the digital picture frame to connect to an online account associated with the digital picture frame.

The digital picture frame may also include a user input means (18) functionally connected to the central processing unit. The inventor envisions user input means known in the art such as a touch screen or an application installed on a general purpose computer capable of modifying the program running on the central processing unit.

The present invention also comprises a method of delivering digital pictures to a digital picture frame without the need for a general purpose computer. Such method comprises the steps of establishing an account to receive communications with digital pictures attached, establishing a connection to the account through a digital picture frame capable of such connection, downloading the communications with digital pictures attached from the account into a memory storage means of the digital picture frame, and displaying the digital pictures.

The digital picture frame must be associated with an account. The user may establish a dedicated e-mail account, associate the digital picture frame with an existing e-mail account, or the digital picture frame may be associated with an e-mail account at the time of manufacture. Alternatively, the digital picture frame may be associated with a cellular telephone account. The digital picture frame may be associated with a dedicated cellular telephone number, an existing cellular telephone number, or some other means of identification accessible to the cellular telephone service provider to uniquely identify the digital picture frame.

Individuals wishing to send digital pictures to the user will attach the digital pictures (2) to an e-mail (3) or text message (9) and send them to the account associated with the digital picture frame. The user will presumably supply an appropriate e-mail address or cellular telephone number to any individuals interested in sending digital pictures to the user. The e-mail or text message is then stored by the e-mail account provider (4) or the cellular telephone service provider (10).

The digital picture frame will then establish a connection to the account with which it is associated and download all of the communications stored in that account (5), (11). Alternatively, where the account is a cellular telephone account, the cellular telephone service provider may push the communications to the digital picture frame by means known in the art (12).

Having downloaded all of the communications in the associated account, the digital picture frame will display the digital pictures attached to said communications (8).

### Preferred Embodiment

The inventor specifically envisions a digital picture frame, known in the art, with integrated cellular telephone data transmission hardware, and the method to use that device to easily receive and display digital pictures without the use of a general purpose computer.

The cellular telephone data transmission hardware would allow the digital picture frame to connect to a cellular telephone service provider. Once connected, the digital picture frame would access a cellular telephone account hosted by cellular telephone service provider.

A connection between the digital picture frame and the cellular telephone service provider may be initiated by the digital picture frame or by the cellular telephone service provider by means known in the art. The inventor envisions that the digital picture frame would be associated with an existing cellular telephone account, or that the digital picture frame would be provided with limited cellular telephone service connectivity solely for the purpose of retrieving messages send to a dedicated account.

The cellular telephone service provider would store messages sent to the account until they were retrieved by the digital picture frame or pushed to the digital picture frame. The digital picture frame would access the account through the cellular telephone data transmission hardware and download any text messages with pictures attached. The digital picture frame may access the account automatically from time to time, or at the express command of the user, or at times initiated by the cellular telephone service provider.

All of the text messages would be filtered based on a pre-established list of trusted senders. The list of trusted senders could be maintained in the memory of the digital picture frame or with the cellular telephone service provider. If the list of trusted senders is maintained with the cellular telephone service provider, then only messages from senders on the list of trusted senders would be downloaded by the digital picture frame. If the list of trusted senders is maintained within the memory of the digital picture frame, then all messages would be downloaded and any message from a sender not on the list of trusted senders would be subsequently deleted.

Pictures attached to messages from senders on the list of trusted senders would be stored in the memory storage means (13), where they would become accessible for display on the display means just as if they were loaded into the digital picture frame by means known in the art.

Information available from the downloaded communication, including but not limited to the e-mail address or cellular telephone number of the sender and the date and time the picture was send, could be converted to metadata and added to the digital picture (7); such metadata could then be used by the digital picture frame to order and display the pictures through means known in the art.

The inventor has hereby disclosed a device and method that satisfies the need to easily transmit and display digital pictures without the need of a general purpose computer.

1: A device, suitable for use as a digital picture frame, such device comprising:
a) a central processing unit,
b) a memory storage means functionally connected to the central processing unit,
c) a wireless data transmission means functionally connected to the central processing unit, and
d) a display means.

2: The device of claim 1 further comprising a user input means functionally connected to the central processing unit.

3: The device of claim 1 further comprising an account hosted by a third-party that receives and stores communications sent to the account, and which may be accessed by the device through the wireless data transmission means.

4: The device of claim 3 further comprising an input means functionally connected to the central processing unit.

5: The device of claim 3 where the account is a cellular telephone account.

6: A method of receiving and displaying digital pictures on a digital picture frame, such means comprising the steps of:
a) establishing an account with a third-party to receive communications with digital pictures attached,
b) establishing a connection to the account through a digital picture frame capable of such connection,
c) downloading the communications with digital pictures attached from the account into a memory storage means of the digital picture frame, and
d) displaying the digital pictures.

7: The method of claim 6 where the connection is a wireless connection established through a cellular telephone service provider.

8: The method of claim 7 where the connection is initiated by the cellular telephone service provider.

9: The method of claim 6 further comprising the steps of:
a) encoding data from the communication as metadata, and
b) incorporating said metadata into the digital picture.

10: The method of claim 6 further comprising the steps of:
a) establishing a list of trusted senders, and
b) filtering out all messages from any sender who is not on the list of trusted senders.

11: The method of claim 10 where the process of filtering is performed by the digital picture frame.

12: The method of claim 10 where the process of filtering is performed by the third-party.
